(19) United States
(12) Patent Application Publication
(10) Pub. No.: US 2013/0024484 A1
(43) Pub. Date: Jan. 24, 2013

(54) SYSTEM MANAGEMENT IN DATACENTER USING A NON-RELATIONAL DATABASE

(71) Applicants: Pradipta K. Banerjee, Bangalore (IN); Pankaj S. Bavishi, Pune (IN); Sanket S. Sangwikar, Pune (IN)

(72) Inventors: Pradipta K. Banerjee, Bangalore (IN); Pankaj S. Bavishi, Pune (IN); Sanket S. Sangwikar, Pune (IN)

(73) Assignee: INTERNATIONAL BUSINESS MACHINES CORPORATION, Armonk, NY (US)

(21) Appl. No.: 13/189,063

(22) Filed: Jul. 22, 2011

(51) Int. Cl. G06F 17/30

(52) U.S. Cl. 707/822; 707/E17.005

(57) ABSTRACT

Systems and methods are disclosed wherein a systems management application uses a non-relational database at its core. Also disclosed is the combined use of a relational database with a non-relational database to selectively store systems management data based on predefined selection criteria. The relational database, if included, comprises a table-based data store that can be queried using a SQL variant. The non-relational database may comprise a file-based data store and consumes UNIX operating system utilities to make faster retrievals from the file-based data store. The novel use of a non-relational database at the core of a systems management application increases performance and scalability in systems management applications.

### BACKGROUND

1. Field of the Invention

The present invention relates to data system management, and more particularly to the storage and retrieval of systems management data.

2. Background of the Related Art

A data center is a facility where computer equipment and related infrastructure are consolidated for centralized operation and management. Computer equipment may be interconnected in a datacenter to produce large, powerful computer systems that are capable of meeting the computing requirements of entities that store and process large amounts of data, such as large corporations, web hosting services, and Internet search engines. A data center may house any number of racks, with each rack capable of holding numerous modules of computer equipment. The computer equipment typically includes servers along with supporting equipment, such as switches, power supplies, network communications interfaces, environmental controls, and security devices. Servers and other devices in a data center are typically mounted in racks in a compact, high-density configuration to make efficient use of space while providing physical access and enabling the circulation of cool air.

The data stored in a data center is a valuable asset of the entity supported by the datacenter. Accordingly, management of the datacenter is important to ensure the integrity of the data. Aspects of datacenter management include managing the data center hardware, software, environmental controls, and data security. A datacenter can be managed largely through software-based platform management applications that monitor systems management data, such as the status, traffic, connectivity, and system configurations involving servers, switches, adapters and other datacenter equipment. Systems management applications typically communicate with the servers and other equipment using established protocols. These protocols are used to retrieve (i.e. fetch) selected information about the systems and store it in a local database.

### BRIEF SUMMARY

A computer-implemented method is disclosed wherein a plurality of computer system devices are monitored, such as in a data center, and systems management data is dynamically obtained from the monitored computer system devices. The systems management data is selectively stored in a non-relational database. The systems management data may be stored in the non-relational database exclusively. Alternatively, predefined selection criteria may be applied to selectively store the systems management data in either the non-relational database or a relational database.

A system is also disclosed that includes a hardware interface, at least a non-relational database, and a resource management service. The hardware interface is configured for monitoring a plurality of computer system devices, such as in a datacenter, and dynamically obtaining systems management data from the monitored computer system devices. The resource management service is in communication with the hardware interface and the non-relational database, and is configured for obtaining systems management data from the computer system devices and selectively storing the systems management data using the non-relational database. In one implementation, the systems management data is stored exclusively in the non-relational database. Another implementation includes the non-relational database and a relational database, and selectively stores the systems management data in either the non-relational database or the relational database.

### BRIEF DESCRIPTION OF THE SEVERAL VIEWS OF THE DRAWINGS

FIG. 1 is a schematic diagram of a datacenter management system that uses a non-relational database, exclusively, for storing systems management data

FIG. 2 is a schematic diagram of an alternative datacenter management system using both a non-relational database and a relational database for storing systems management data.

FIG. 3 is a flowchart outlining a method of computer system management combining the use of a relational database with a non-relational database.

### DETAILED DESCRIPTION

Systems and methods are disclosed that incorporate a non-relational database at the core of a systems management application. Systems and methods are also disclosed that combine the use of a relational database and a non-relational database, by selectively storing systems management data in the relational database and the non-relational databases according to predefined selection criteria. The relational database has a table-based data store that can be queried using SQL or one of its several variants, all of which are categorically referred to as SQL in this disclosure. The non-relational database, by comparison, instead has a file-based data store that may be queried with UNIX operating system utilities to make faster data retrievals. The term “NoSQL” is used herein to refer to a broad class of such non-relational database management systems. The file-based data store of a NoSQL database provides integrated support for text searching with fields. This de-normalized aspect of NoSQL avoids the use of resource-intensive JOIN operations often used when searching with SQL, along with other operations that rely on JOIN operations, such as SELECT statements. Therefore, employing the non-relational database for at least some of the systems management data storage as taught herein is an effective way to increase performance and improve scalability in systems management applications.

When combining the use of a relational database and a non-relational database in a systems management application, predefined selection criteria may be applied to determine which of the two types of data stores is used to store each item of systems management data. For example, the endpoints that are not data intensive or require ACID (atomicity, consistency, isolation, durability) transactions can be stored in the SQL tables, and the rest can be stored in the NoSQL files. The frequency with which the data is changing may also be used as selection criteria for determining where to store each item of data, by storing frequently changing data in the SQL database and infrequently changing data in the NoSQL database. For instance, the properties of the endpoints that change frequently, like status updates, can be stored on SQL database, whereas the properties of the endpoints that change less frequently, like inventory data, manufacturer, model ID, serial number, hosted batteries, ports and LAN connections can be stored in NoSQL. As another example of selection criteria, relationships may be stored in the SQL database only with identifiers, while properties and objects may be stored in the NoSQL database. Selection criteria may be predetermined and manually input by an operator. Additionally, endpoints can also be classified dynamically based on trending or data center policies. The selection criteria to be applied in distributing the systems management data among the SQL and NoSQL databases could also be based on maps that are predefined or dynamically updated as part of a continuous learning process.

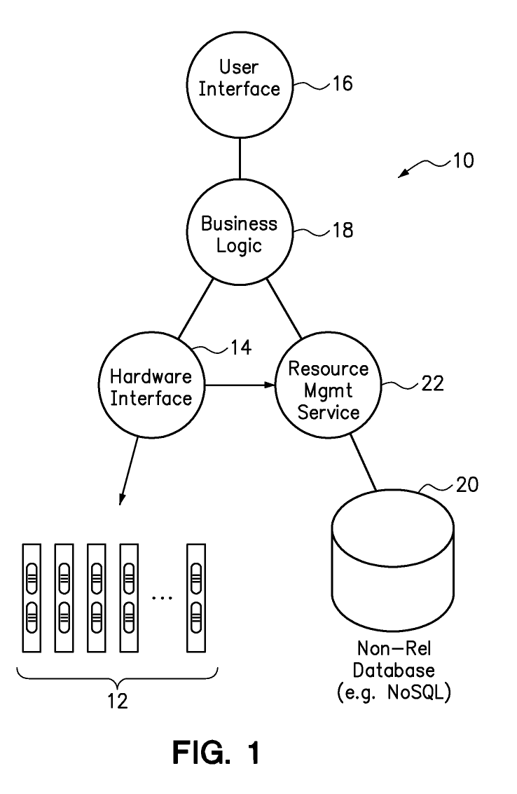

FIG. 1 is a schematic diagram of a datacenter management system 10 that uses a non-relational database 20, exclusively, for storing systems management data. The datacenter computer equipment to be managed includes a plurality of computer system devices 12, which are schematically shown to include a plurality of servers. The computer system devices 12 may further include other computer equipment to be managed, such as switches, storage devices, servers, hypervisors, virtual machines, operating systems, routers, blade center devices, and so forth. A hardware interface 14 is in communication with the computer system devices 12. The hardware interface 14, so-called because it interfaces with the hardware of the computer system devices 12, may itself include both hardware and software elements for monitoring the computer system devices 12 and dynamically obtaining systems information from the computer system devices 12. The systems management data is stored in the non-relational database 20, which may be a NoSQL database. The systems management data may then be selectively retrieved from the non-relational database without the use of SQL-type commands.

The systems management data referred to herein includes any information about the computer system devices 12 that could factor into the management of the computer system devices. General categories of systems management data include, for example, (1) the names and identifiers of the devices (e.g. the hostname of a server and its type), (2) the status of each computer system device 12 (e.g. power states and accessibility states such as access OK, error, or partial error), (3) the properties/attributes of a device, (4) relationships between two or more computer system devices 12, and (5) relationships between computer system devices 12 and components of the computer system devices, such as adapters and batteries. (The name of a server typically refers to its hostname, whereas the identifier includes additional description information such as type. The status of a device may include its power state, and/or an accessibility state such as “access OK,” “error,” and “partial error.” Examples of relationships include a “hosted” relationship between devices, where one computer system is hosted on the other, and a “managed by” relationship where one computer system is managed by another computer system.) Most of the systems management data in these five categories does not change very frequently. Accordingly, it is not imperative to frequently update this systems management data in the database 20. Because the systems management data does not require frequent update, it is feasible to manage systems management data using the non-relational database 20, exclusively, in this embodiment of a system. Thus, all of these five categories of attributes can be monitored using the non-relational database, such as a NoSQL database, without much risk for a system management application.

The datacenter management system 10 further includes a user interface 16. The user interface 16 allows a human user to interface with the rest of the datacenter management system 10. In particular, the user interface 16 may include hardware elements, such as user input and output (I/O) peripherals for inputting data and monitoring system management information. The user interface 16 may include a keyboard and pointing device, for example, for selectively requesting and monitoring systems management data from the non-relational database 20, and optionally for inputting management parameters used to manage the computer system devices 12.

A business logic module 18 is also included with the datacenter management system 10. The business logic module 18, alternately referred to as domain logic, comprises functional algorithms that handle exchange of systems management data between the non-relational database 20 and the user interface 16. In a single-tier application, for example, business logic, presentation logic, and the four basic functions of persistent storage referred to as “CRUD” (create, read, update, and delete) are often used. In a multilayered architecture (compared to multitier architecture), business logic is a separate module. In a three-tier architecture, the business logic in theory occupies the middle tier, the business-services tier or business layer. In practice, the business logic is often interwoven in the other two tiers (the user services tier and the database services tier), such as by encoding business logic in stored procedures and in decisions about input validation and display formatting. The business logic module provides implementation of the various systems management flows or functions that is provided by the systems management software as a whole, such as by creating a virtual machine, relocating a virtual machine, deploying a workload to a system pool, migrating a workload, and automating an event.

A Resource Management Service (RMS) 22 is included with the datacenter management system 10 and interfaces with the non-relational database 20 to dynamically store systems management data obtained from the computer system devices 12. RMS generally also provides for caching and is a commonly used software component in systems management application. The RMS 22 in the disclosed system may also selectively retrieve systems management data stored in the non-relational database 20. The RMS 22 extracts systems management data from the computer system devices 12 and stores the systems management data in the non-relational database 20 in a manner that is desirably transparent to the rest of the datacenter management system 10. That is, the business logic 18 of the datacenter management system 10 is not affected by whether the RMS 22 is using the non-relational database 20, as shown, versus using a conventional relational database. Thus, for example, the business logic module 18 does not need to traverse any relationships or know about any relationship or schema used by the RMS 22 in order to store and retrieve systems management data from the non-relational database 20.

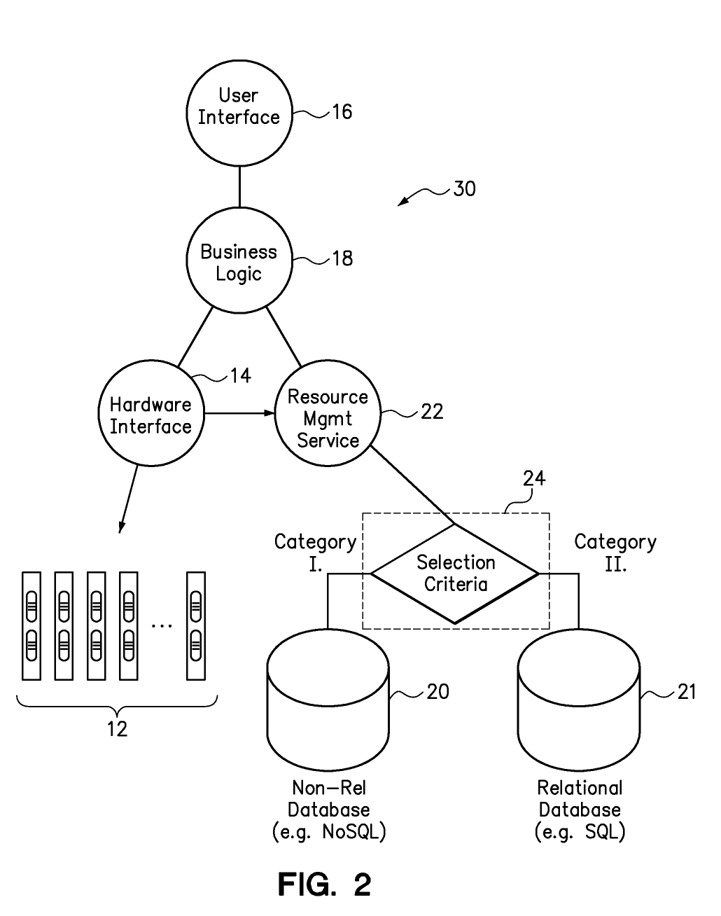

FIG. 2 is a schematic diagram of another datacenter management system 30 wherein the non-relational database 20 is used along with a relational database 21 for storing systems management data. The respective architectures of the datacenter management system 10 and the datacenter management system 30 of FIG. 2 have some common elements. For example, the architecture of the datacenter management system 30 in FIG. 2 also includes a hardware interface 14 configured for monitoring a plurality of computer system devices 12 and dynamically obtaining systems management data from the monitored computer system devices 12. The architecture of the datacenter management system 30 in FIG. 2 further includes an RMS 22 in communication with the hardware interface 14 and configured for obtaining systems management data from the computer system devices 12 and selectively storing the systems management data. In the system 30, as in the system 10, the business logic module 18 is in communication with the hardware interface 14 and the user interface 16 for handling the exchange of information between the hardware interface 14 and the user interface 16.

The datacenter management system 30 of FIG. 2 is different, however, in that it combines the use of the non-relational database 20, such as in a flat file-based, NoSQL environment, with a relational database 21, such as in a table-based SQL environment. Predefined selection criteria 24 are applied to selectively determine whether to store each item of systems management data in the non-relational database 20 or the relational database 21. Again, the manner in which the RMS 22 operates to store and retrieve systems management data from the combined non-relational database 20 and relational database 21 may be transparent to the rest of the architecture of the datacenter management system 10.

The RMS 22 applies the selection criteria 24 to selectively store systems management data in either the non-relational database 20 or the relational database 21. In FIG. 2, this process is generally diagrammed as separating the systems management data into one of two general categories (Categories I and II). Category I systems management data is stored in the non-relational database 20, and Category II systems management data is stored in the relational database 21. Any number of selection criteria may be applied to determine whether each the item of information belongs to Category I or Category II. For example, systems management data may be generally classified according to the actual or expected frequency at which the systems management data changes. Systems management data that changes infrequently, or is expected to change infrequently, may be stored in the non-relational database 20, and systems management data that changes or is expected to change more frequently may be stored in the relational database 21. The issue of whether an item of data changes frequently or infrequently may be determined dynamically, such as by obtaining the actual frequency of change and comparing the frequency to a threshold frequency of change. Alternatively, different types of data may be categorized by a user in advance as either frequently changing or infrequently changing.

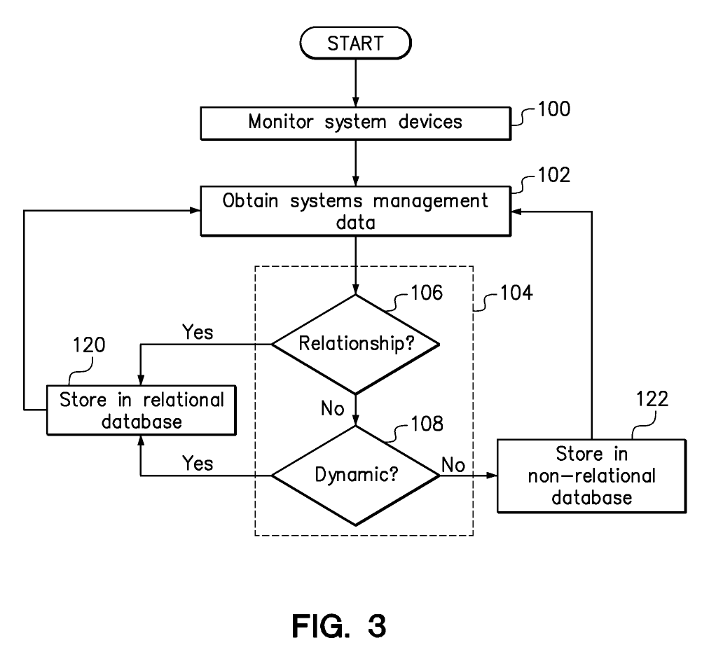

FIG. 3 is a flowchart outlining a method of system management in a datacenter combining the use of a relational database with a non-relational database. The relational database uses table-based data stores while the non-relational database uses file-based data stores. In step 100, a plurality of systems devices are monitored. Systems devices may include any of a variety of computer equipment, and particularly rack-mounted computer equipment of the type commonly found in a datacenter. For example, the systems devices may include a plurality of servers. The computer system devices may be monitored by a hardware interface in communication with the servers and other computer system devices. Step 102 involves obtaining systems management data from the monitored systems devices, and storing that data across the relational database and the non-relational database. The systems management data may include, for example, the names or other identifiers of the computer system devices, the status of each computer system device, the properties and attributes of each computer system device, the relationships between servers, and the relationships between servers and other computer system devices like adapters, a battery, and so forth.

A subroutine generally outlined at 104 involves applying a map of selection criteria to determine whether each item of systems management data obtained from the monitored computer system devices in step 102 is to be stored in the relational database or in the non-relational database. A plurality of different criteria may be included in the map of selection criteria, in addition to or in lieu of what is shown. Two example criteria are shown in this example. One criterion embodied in conditional step 106 is to determine whether the particular systems management data being evaluated defines a relationship between devices. If so, the systems management data may be stored in the relational database per step 120. Otherwise, the data is deemed to be device-specific. Another criterion embodied in conditional step 108 is to determine whether the systems management data is frequently changing (i.e. dynamic) or infrequently changing (i.e. static). Many types of systems management data listed above change infrequently, and therefore do not require frequent updates. Dynamic systems management data may be stored in the relational database according to step 120. Otherwise, the systems management data is deemed to be static. Systems management data that does not define a relationship between devices per conditional step 106 and that is static per conditional step 108 is stored in the non-relational database per step 122.

Some of the criterion in the map of selection criteria may be either evaluated dynamically or predetermined. The frequency with which a particular item of systems management data changes, for example, may be actively measured and compared to a threshold to determine whether that data is to be considered dynamic. Alternatively, different types of data may be predetermined to be static or dynamic. For example, the names or other identifiers of the computer system devices, the statuses of the systems devices, the properties and attributes of the computer system devices, and the relationships between devices may be categorically considered static or infrequently changing.

The categorization of queries used to selectively store data in the relational or non-relational databases may be implemented by a Resource Management Service (RMS), such as described above. Each time before a query is submitted to request systems management data, the RMS may determine whether the query is a traversal type query (in the case of NoSQL) or an enumeration type query (in the case of SQL). The RMS may then process the request to the databases according to this determination. The categorization may be stored in a static map for referral by the RMS. Categorization of the queries will work seamlessly, irrespective of the logic above the RMS. If the query is a traversal type query, the non-relational database may be selected; otherwise, if the query is an enumeration type query, the relational database may instead be selected. The RMS may then select an appropriate protocol, depending on which of the two databases is indicated. For example, the RMS may execute a SQL type query for probing the table-based data stores of the relational database or by using UNIX OS utilities to perform a text search of the file-based data store of the non-relational database, depending on the case.

Database migration may be simplified according to the above methods, as many of the manageable elements of the systems management data are stored in a non-relational NoSQL type database. In the case of a system or methods using only a non-relational database, migration can be performed without any overhead. Some amount of overhead may be required, however, in a system or method that incorporates both a relational database and a non-relational database, such as in managing the information regarding relationships between devices. “Relationships” in systems management applications refers to the relationships between the computer systems or its constituent devices. Relationships can be moved, with some level of overhead. Alternatively, if the relationships are not required to be maintained as part of a systems management policy, then the relationships can be very easily reconstructed as long as the manageable elements of the systems management data are maintained. For example, in the case of a “hosted” relationship where Computer System A is hosted on Computer System B, this relationship can be either entered manually or can be derived automatically by looking into various properties of the system A and B. Deriving the relationship is synonym to constructing the relationship. Reconstructing the relationship involves deleting/purging the relationship and deriving it again by looking into various properties of the system.

Within the above described systems, the data model (i.e. how the physical objects like computers, storage, adapter etc are modeled and used in software) used to traverse the object for selectively storing and retrieving data from the relational database (e.g. SQL) and the non-relational database (e.g. NoSQL) may be kept separate. Both the data models can be synchronized using a JOIN operation in cases where synchronization is required. NoSQL may provide a suite of application programming interfaces (APIs) allowing developers to add data to the data structures spontaneously, without having to pass through a batch ETL (Extract/Transform/Load) process. An ETL process is generally understood as a process in database usage that involves extracting data from outside sources, transforming the data to fit operational needs, and loading the data into the end target, such as a database. An ETL process can still be used if desired, but is no longer necessary because of the commit/rollback capabilities of NoSQL. The changes may be made on the server side and not on the agent or client machines. This is hence, effectively implementable and does not have to be updated for each managed endpoint.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method, comprising:
monitoring a plurality of computer system devices;
dynamically obtaining systems management data from the monitored computer system devices; and
selectively storing the systems management data in a non-relational database.

2. The method of claim 1, further comprising:
storing the systems management data using the non-relational database, exclusively.

3. The method of claim 1, further comprising:
applying predefined selection criteria to select the systems management data to store in the non-relational database; and
applying the predefined selection criteria to select other systems management data to store in a relational database.

4. The method of claim 3, further comprising
storing systems management data specific to one computer system device in the non-relational database

5. The method of claim 3, further comprising:
storing systems management data defining a relationship between two or more of the computer system devices in the relational database.

6. The method of claim 3, further comprising:
storing frequently changing data in the relational database; and
storing infrequently changing data in the non-relational database.

7. The method of claim 3, wherein the relational database uses a table-based data store and the non-relational database uses a file-based data store.

8. A system, comprising:
a hardware interface configured for monitoring a plurality of computer system devices and dynamically obtaining systems management data from the monitored computer system devices;
a non-relational database; and
a resource management service in communication with the hardware interface and the non-relational database, the resource management service configured for obtaining systems management data from the computer system devices and selectively storing the systems management data using the non-relational database.

9. The system of claim 8, wherein the resource management service is configured to store the systems management data using the non-relational database, exclusively.

10. The system of claim 8, further comprising:
a user interface;
a business logic module in communication with the hardware interface and the user interface for handling the exchange of information between the hardware interface and the user interface; and
wherein the resource management service stores and retrieves the systems management data independently of the business logic module.

11. The system of claim 8, further comprising:
a relational database; and
wherein the resource management service is further in communication with the relational database and is configured for both selectively storing the systems management data using the non-relational database and selectively storing other systems management data using the relational database.

12. The system of claim 11, wherein the resource management service comprises predefined selection criteria and is configured for applying the predefined selection criteria to determine whether to store the systems management data in the relational database or the non-relational database.

13. The system of claim 12, wherein the resource management service is configured to store systems management data specific to one computer system device in the non-relational database and to store systems management data defining a relationship between two or more of the computer system devices in the relational database.

14. The system of claim 11, wherein the relational database comprises a structured query language (SQL) database and the non-relational database comprises a non-SQL database.

15. A computer program product including computer usable program code embodied on a computer usable storage medium, the computer program product comprising:
computer usable program code for monitoring a plurality of computer system devices;
computer usable program code for dynamically obtaining systems management data from the monitored computer system devices; and
computer usable program code for selectively storing the systems management data in a non-relational database.

16. The computer program product of claim 15, further comprising:
computer usable program code for applying predefined selection criteria to select the systems management data to store in the non-relational database; and
computer usable program code for applying the predefined selection criteria to select other systems management data to store in a relational database.

17. The computer program product of claim 16, further comprising
computer usable program code for storing systems management data specific to one computer system device in the non-relational database

18. The computer program product of claim 16, further comprising:
computer usable program code for storing systems management data defining a relationship between two or more of the computer system devices in the relational database.

19. The computer program product of claim 16, further comprising:
computer usable program code for storing frequently changing data in the relational database; and
computer usable program code for storing infrequently changing data in the non-relational database.

20. The computer program product of claim 16, wherein the relational database uses a table-based data store and the non-relational database uses a file-based data store.
